(19) United States
(12) Patent Application Publication
(10) Pub. No.: US 2008/0250905 A1
(43) Pub. Date: Oct. 16, 2008

(54) CROWN MOLDING AND DOOR INSTALLATION TOOLS

(76) Inventor: VIKTOR KHAN, Fullerton, CA (US)

Correspondence Address: STETINA BRUNDA GARRED & BRUCKER, 75 ENTERPRISE, SUITE 250, ALISO VIEJO, CA, 92656, US

(21) Appl. No.: 12/102,572

(22) Filed: Apr. 14, 2008

Related U.S. Application Data
(60) Provisional application No. 60/923,426, filed on Apr. 13, 2007.

(51) Int. Cl. B26D 7/02

(52) U.S. Cl. 83/23; 269/41; 269/45; 83/466.1

(57) ABSTRACT

A crown molding jig may have a first guide and a second guide. Each of the guides may be sized and configured to receive a crown molding. A saw guide may be disposed between the first and second guides for guiding a saw blade and cutting a compound angle cut in the crown molding. A crown molding holder may have a base member for engaging the crown molding and an extension pole pivotally attached to the base member such that the crown molding holder may be wedged between the crown molding disposed at the ceiling and the floor. A door installation jig may have a U-shaped member sized and configured to receive a door and an inflatable tube for lifting the door to position adjacent a door frame.

### CROSS-REFERENCE TO RELATED APPLICATIONS

This application claims the benefit of U.S. Prov. Pat. App. Ser. No. 60/923,426, filed on Apr. 13, 2007, the entire contents of which are incorporated herein by reference.

### STATEMENT RE: FEDERALLY SPONSORED RESEARCH/DEVELOPMENT

Not Applicable

### BACKGROUND

The present invention relates to a crown molding jig, a crown molding bolder and a door installation tool.

Crown molding is typically installed in a room about a portion of or about the entire inner periphery of the ceiling of a room. One of the difficult steps in installing the crown molding is forming the joint at the corner of the room. In particular, at the corner of the room, two crown molding pieces are joined to each other. To join the two crown molding pieces seemlessly, a compound angle cut must be made at the distal end portions of the mating crown moldings. Unfortunately, forming or cutting the compound angle such that the crown moldings seamlessly mate with each other is difficult or complicated even for a professional installer. The reason is that the compound angle formed on a first crown molding plus the compound angle formed in the second crown molding must be substantially equal to (not less than or greater than) the angle of the corner such that the exterior edges of the first and second crown molding may be flush with each other to form an aesthetically pleasing joint.

Prior art miter saws have accurate adjustments which allow the crown molding installer to cut compound angles. An exemplary miter saw is the 10″ laser compound miter saw sold under the trademark RYOBI, which permits compound angle cuts for installing crown molding. However, prior art miter saws must be set to cut the first crown molding and mating second crown molding separately. In particular, the installer sets the miter saw to make the compound angle cut for the first crown molding then makes the compound angle cut in the first crown molding. Thereafter, the installer readjusts the prior art miter saw in an opposite direction to make the compound angle cut for the second crown molding then makes the compound angle cut in the mating second crown molding. If compound angle cut in the first and/or second crown molding is not perfect, then the installer must readjust the prior art miter saw to make the appropriate cut. Additionally, it is also confusing to keep track of the compound angle cut for the first and second crown molding. Sometimes crown molding installers are confused whether the compound angle cut is set correctly. Typically, even those with experience in installing crown molding may mistakenly make an incorrect compound angle cut. For example, they may make a compound angle cut appropriate for the second crown molding on the first crown molding, and vice versa.

Another deficiency in prior art miter saws for cutting compound angle cuts in crown molding is that prior art miter saws are pre marked for ninety degree walls such that the installer may set the saw blade to the pre marked angles to join adjacent crown molding adjacent to each other. Unfortunately, adjacent walls may appear to be ninety degrees but when measured the angle between adjacent walls may be a few degrees more or less than ninety degrees. Hence, the pre marked angles set on the prior art miter saws still create a gap between the mating crown moldings when installed.

Additionally, installing crown molding in furnished homes is time consuming and/or messy. The reason is that cutting crown molding creates dust in the surrounding area. If the crown molding is cut outside then brought inside, then the interior of the home remains clean (i.e., not dusty) but the installer must repeatedly trek in and out of the home to measure, cut, test, re-cut, test and install the crown molding. Alternatively, if the crown molding is cut inside then the installer does not have to repeatedly trek in and out of the home but the interior of the home may become dusty.

Installation of crown molding is also expensive not only due to the difficulty of forming perfect joints but also due to the manpower involved. Crown molding is provided to construction workers in long pieces (e.g., 12 feet, 14 feet, etc.). To install the crown molding, a first person must hold the crown molding up to the ceiling of the room. A second person must then nail the crown molding into the ceiling and/or the walls of the room. As such, installation of the crown molding is a two person job. Additionally, to form the compound angle, the construction worker must cut the compound angle in the crown molding and test whether the joint between the first and second compound moldings is perfectly aligned to each other. To this end, the first construction worker must hold the first crown molding up to the ceiling of the room while the second construction worker aligns the distal end of the second crown moldings to see whether the joint is acceptable.

In remodeling homes, installation of heavy doors is typically a two person process. The first person will hold up the door, while the second person attaches the hinge to the door and the door frame. Unfortunately, the two person process is very expensive due to the labor involved.

### BRIEF SUMMARY

The present invention addresses the deficiencies discussed above, discussed below and those that are known in the art.

A crown molding jig having first and second guides sized and configured to securely receive first and second crown moldings respectively is provided. The first and second guides 30a, b may be at a fixed angle with respect to each other (e.g., 90°, 270°). Alternatively, the angular relationship between the first and second guides 30a, b may be adjustable with respect to each other. The specific ranges of angles provided herein are merely provided as examples and are not meant to limit the crown molding jig to the stated angles. Other angles may be incorporated into the crown molding jig. Moreover, a saw guide may be disposed between the first and second crown molding guides for guiding a hand operated saw to cut the first and second crown molding.

In an aspect of the crown molding jig, the same may be attached to a miter saw or placed over a bucket to collect dust particulate.

To install crown molding, a crown molding holder is provided which may have an upper holding member for engaging the crown molding. The upper holding member may be pivotably attached to an extension pole. An opposed distal end of the extension pole may have a gripping surface. In use, the crown molding holder is wedged between the crown molding disposed adjacent the ceiling and the floor.

In an aspect of the crown molding holder, the extension pole may be spring loaded.

In relation to the door installation jig, the same may have a U-shaped channel with an inflatable tube disposed within the channel for raising a door. The inflatable tube may be filled with air via a pump (e.g., foot pump) to raise the door when installing the door.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a crown molding jig placeable on a five gallon bucket;

FIG. 2 is a side cross sectional view of the crown molding jig shown in FIG. 1 mounted to an electric miter saw;

FIG. 3 is a front perspective view of an adjustable crown molding jig;

FIG. 4 is a rear perspective view of the adjustable crown molding jig shown in FIG. 3 mounted to an electric miter saw;

FIG. 5 is a perspective view of a crown molding holder;

FIG. 6 is an enlarged perspective view of an upper holding member and paint roller holding a crown molding against a ceiling of a room;

FIG. 7 is a perspective view of a door installation jig and a foot pump for assisting in installation of a door;

FIG. 8A is a cross sectional view of the door installation jig shown in FIG. 7 illustrating optional flanges and stiffening ribs; and

FIG. 8B is a cross sectional view of a door installation jig wherein opposed vertical walls are formed with an outward angle.

### DETAILED DESCRIPTION

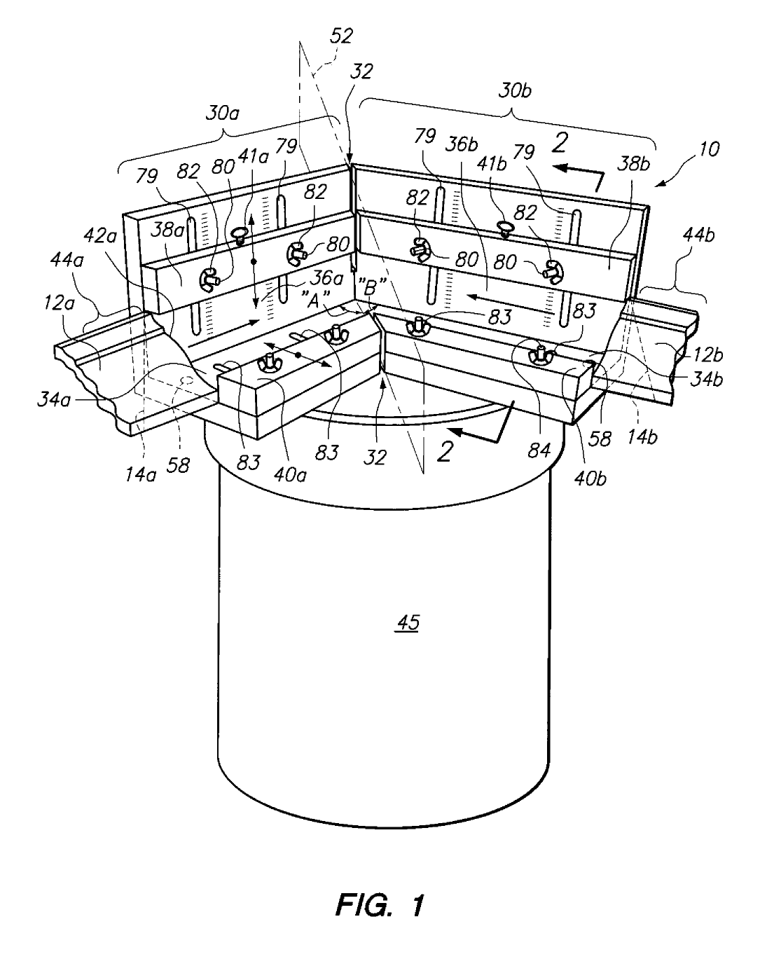

FIGS. 1-2 and 3-4 respectively illustrate a fixed embodiment and an adjustable embodiment of a crown molding jig 10, 10a for forming a compound angle cut in crown molding 12. The crown molding jig 10, 10a may be utilized to form the compound angle cut on a first crown molding 12a and a compound angle cut on a second crown molding 12b such that the distal exterior edges 14a, b (see FIG. 1) of the first and second crown moldings 12a, b are flush to each other when the first and second crown moldings 12a, b are butted up against each other. The crown molding jig 10, 10a may be a single jig that aligns a cutting blade 52 to the first and second crown moldings 12a, b such that a compound angle cut may be formed on the first and second crown moldings 12a, b without independently adjusting the cutting blade 52, the jig 10, 10a or saw 50 to the first crown molding 12a to form the compound angle cut, then thereafter, independently readjusting the cutting blade 52 or the jig 10, 10a to form the compound angle cut on the second crown molding 12b. It is contemplated that a single adjustment of the cutting blade 52, miter saw 50, or jig 10, 10a is able to set the cutting blade 52 to cut the compound angle cut in adjacent mating crown moldings 12. The crown molding installer may also test whether the distal exterior edges 14a, b of the first and second crown moldings 12a, b are flush with each other by inserting both the first and second crown moldings 12a, b in the crown molding jig 10, 10a at the same time. In the fixed embodiment of the crown molding jig, the crown molding jig 10 may be utilized to cut compound angle cuts in the first and second crown moldings 12a, b such that the first and second crown moldings 12a, b may be assembled either at 90 degrees or 270 degrees. In the adjustable embodiment of the crown molding jig, the crown molding jig 10a may be utilized to cut compound angle cuts in the first and second crown moldings 12a, b such that the first and second crown moldings 12a, b may be assembled at a range of angles, preferably between about 60° and 135° or about 300° and 225°. In the crown molding jigs 10, 10a, the same may be designed for other angles.

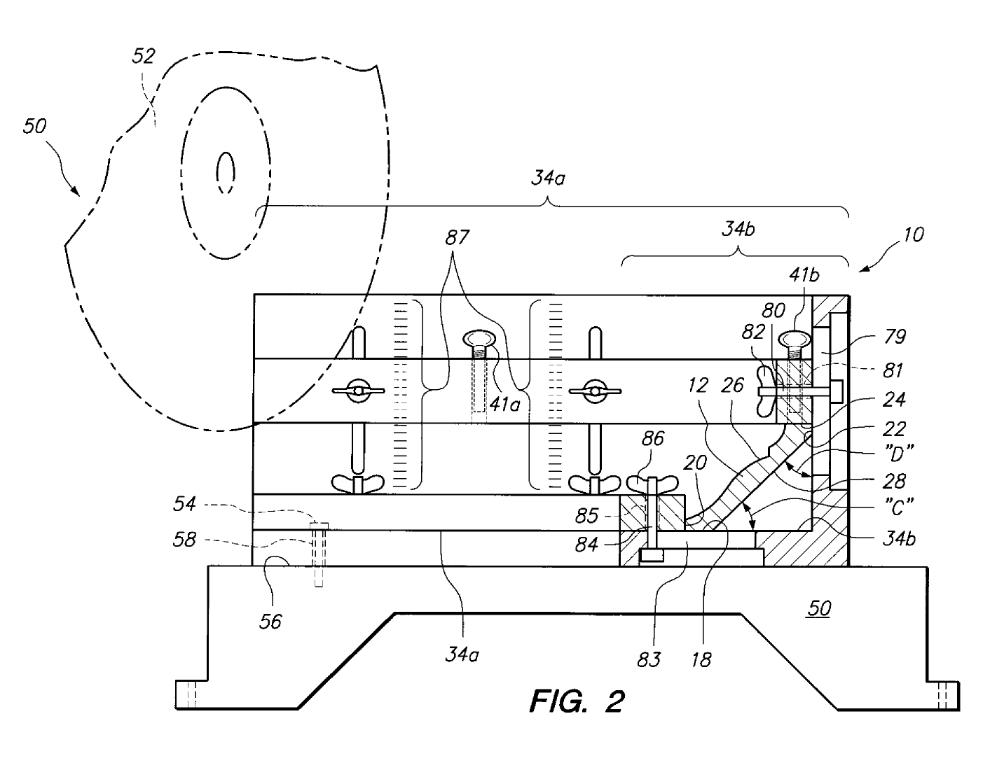

As a preliminary matter, as shown in FIG. 2, typically, crown molding 12 may have a ceiling engaging surface 18 and a front surface 20 which form a 90° angle. Moreover, the crown molding 12 may have a wall engaging surface 22 and a bottom surface 24 forming a 90° angle with respect to each other. The ceiling engaging surface 18, front surface 20, wall engaging surface 22 and the bottom surface 24 collectively define a rectangular or square shape, as shown in FIG. 2. The crown molding 12 may also define an exterior surface 26 which may have various decorative carvings or prints. The crown molding 12 may also have a flat interior surface 28 which extends from the ceiling engaging surface 18 to the wall engaging surface 22. Preferably, the ceiling engaging surface 18 and the interior surface 28 forms an angle “C” equal to about 58° or 52°, whereas, the wall engaging surface 22 and the interior surface 28 forms an angle “D” of about, 32° or 38° respectively. Although one type of crown molding 12 with specific dimensions and angles is described herein and used to illustrate the various advantages of the crown molding jig 10, 10a, other types of crown molding may be cut with the crown molding jig 10, 10a. The particular type of crown molding 12 discussed herein is only used for the purpose of illustration and not limitation.

In a first embodiment of the crown molding jig 10, the same may have three different guides 30a, b and 32, as shown in FIG. 1. Guides 30a, b are respectively for the first and second crown moldings 12a, b. The guide 32 guides the saw blade 52 to cut the compound angle cuts in the crown moldings 12a, b.

Each of the guides 30a, b for the crown molding 12a, b may have a bed surface 34a, b for resting the crown molding 12a, b while cutting the crown molding 12a, b. Each of the guides 30a, b for the crown molding 12,b may also have a back surface 36a, b for propping the crown molding 12a, b up at a particular angle. The back surface 36a, b may form a 90° angle with the bed surface 34a, b. The first and second guides 30a, b may have an upper block 38a, b and a lower block 40a, b which rotationally locks the crown molding 12a, b in the guide 30a, b about a longitudinal axis of the respective guides 30a, b such that the crown molding 12a, b does not rotate about the longitudinal axis of its respective guide 30a, b. In use, the crown moldings 12a, b may freely or with slight resistance be longitudinally inserted into and removed from the respective crown molding guides 30a, b. It is also contemplated that jam screws 41a, b (e.g., screw, bolt, pin, etc.) may be attached to the crown molding jig 10 at the first and second guides 30a, b to lock the crown molding 12 in the guides 30a, b in the longitudinal direction (see FIGS. 1 and 2). By way of example, the upper block 38a, b may have a threaded hole. A bolt or screw 41 may be threaded into the threaded hole. To lock the crown molding in the guide, the bolt or screw may be tightened until a distal end of the bolt or screw contacts the bottom surface 24 or ceiling engaging surface 18 of the crown molding 12.

As stated above, the crown molding jig 10 may be utilized to form compound angle cuts on the distal end portions 44a, b of the crown moldings 12a, b such that the distal exterior edges 14a, b (see FIG. 1) of the first and second crown moldings 12a, b may be flush with each other when the first and second crown moldings 12a, b are butted up against each other. The guides 30a, b of the crown molding 10 shown in FIGS. 1 and 2 are fixed and do not pivot or rotate with respect to each other. In the crown molding jig 10 shown in FIGS. 1 and 2, the distal exterior edges 14a, b of the first and second crown moldings 12a, b are flush with each other when the first and second crown moldings 12a, b are oriented at 90° or 270° with respect to each other. As will be discussed below, in the second embodiment of the crown molding jig 10a, the guides 30a, b may be oriented to each other at different angles such that the distal exterior edges 14a, b of the first and second crown moldings 12a, b are flush with each other at other angles including 90° or 270°.

To use the crown molding jig 10, the first crown molding 12a may be chop cut to a measured length of a wall plus ⅛″ to ¼″ to allow for the compound angle cut to be made in the first crown molding 12a. The first crown molding 12a may then inserted into the guide 30a. The ceiling engaging surface 18 lays flat or rests upon the bed surface 34a. Also the wall engaging surface 22 lays flat or rests upon the back surface 36a. The upper block 38a and the lower block 40a engages the bottom surface 24 and the front surface 20 respectively such that the first crown molding 12a is wedged in the first guide 30a (i.e., the first crown molding 12a can be slid in and out of the guide 30a but cannot rotate within the guide 30a). The first crown molding 12a may be inserted or fed through the first guide 30a until its distal end 42a contacts the back surface 36b of the second guide 30b. Alternatively, the first crown molding 12a may be inserted or fed through the first guide 30a until a cut mark is aligned to the saw guide 32. With the distal end 42a of the first crown molding 12a inserted into the guide 30a, a saw blade 52 is fed through the saw guide 32 and reciprocated to make the compound angle cut in the distal end portion 44a of the first crown molding 12a. The first crown molding 12a may be removed from the guide 30a.

Similarly, the second crown molding 12b may be chop cut to a measured length of a wall plus ⅛″ to ¼″ to allow for the compound angle cut to be made in the second crown molding 12b. The second crown molding 12b may then may then be inserted through the second guide 30b in a similar manner that the first crown molding 12a is inserted through the first guide 30a. The saw blade 52 may then be inserted through the saw guide 32 and reciprocated to make the compound angle cut in the distal end portion 44b of the second crown molding 12b. The distal end portions 44a, b of the first and second crown moldings 12a, b each have a compound angle cut. When the first and second crown moldings 12a, b are oriented at a 90° or 270° angle with respect to each other, the distal exterior edges 14a, b of the first and second crown moldings 12a, b are flush with each other to form a seamless joint. In this manner, the first and second crown moldings 12a, b may be installed in a 90° or 270° angle corner of a room.

The saw guide 32 is disposed or formed between the crown molding guides 30a, b such that the angle “A” (see FIG. 1) defined by the guide 30a and saw guide 32 is equal to the angle “B” (see FIG. 1) defined by the guide 30b and saw guide 32. In the crown molding jig 10 shown in FIG. 1, the angles “A” and “B” are equal to 45°. These angles are merely provided as examples and are not used to limit the scope of the crown molding jig. Other angles are also contemplated. The crown molding jig 10 may be fabricated such that the guides 30a, b are set at different angles with respect to the saw guide 32; however, the angles “A” and “B” are preferably equal to each other. The saw guide 32 is shown in FIG. 1 as an upper slot formed between the back surfaces 36a, b and a lower slot formed between the bed surfaces 34a, b. The slots may be wide enough to fit a hand saw, a blade of a miter saw or other type of cutting device. It is contemplated that the saw guide may have other configurations.

The crown molding jig 10 may also be utilized to test whether the compound angle cuts formed in the distal end portions 44a, b in the first and second crown moldings 12a, b properly mate with each other. In particular, the first crown molding 12a may be inserted through the guide 30a. Also, the second crown molding 12b may be inserted through the second guide 30b. The distal exterior edges 14a, b of the first and second crown moldings 12a, b may be aligned and pushed together so as to be flush with each other. If the distal exterior edges 14a, b of the first and second crown moldings 12a, b cannot be pushed together so as to be flush against each other, then the compound angle cuts made in the first and second crown moldings 12a, b were made incorrectly. On the other hand, if the distal exterior edges 14a, b of the first and second crown moldings 12a, b can be pushed together so as to be flush with each other, then the compound angle cuts formed in the distal end portions 44a, b of the first and second crown moldings 12a, b were properly formed. The crown molding jig 10 simulates the 90° angle of the room. The first and second crown moldings 12a, b may be removed from the crown molding jig 10 and installed in the corner of the room confidently knowing that the distal exterior edges 14a, b of the first and second crown moldings 12a, b will be flush with each other when the first and second crown moldings 12a, b are installed in the room.

The compound angle cut made in the crown moldings 12a, b may be made within the room in which the crown moldings 12 are installed. Cutting wood in a home is very dusty, especially with a power miter saw. Dust particulate floats within the air and permeates the entire room and other adjacent rooms in the home. As such, typically, the crown molding installer must cut the crown molding outside of the home to ensure that the dust particulate does not enter the furnished home and make the home messy with dust. Beneficially, the crown molding jig 10 may be used in the room in which the crown molding is to be installed. In particular, the crown molding jig 10 may be rested upon a five gallon paint bucket 45, as shown in FIG. 1. The crown moldings 12a, b are cut as discussed above. As the saw blade 52 reciprocates through the saw guide 32, dust particulate from the crown molding 12 falls into the five gallon paint bucket 45. As such, cleanup is convenient and easy. Moreover, a vacuum nozzle may be placed adjacent the crown molding jig 10 (and more particularly, adjacent the saw guide 32) to collect any floating dust particulate into the vacuum as the crown molding 12a, b is being cut to further reduce the spread of dust.

As shown in FIG. 2, the crown molding jig 10 may also be used in conjunction with an electric saw 50 such as a miter saw (e.g., prior art ryobi 10″ miter saw discussed in background), a radial saw, and the like for cutting compound angles. The electric saw may have a laser beam guide for indicating the cutting location of the blade 52. Typically, the electric saw 50 will have two bolts 54 (one of which is shown in FIG. 2) which attach a back gage to the bed 56 of the electric saw 50. To mount the crown molding jig 10 to the bed 56 of the electric saw 50, the two bolts 54 attaching the back gage to the bed 56 of the electric saw are removed. The back gage is removed from the bed 56 and replaced with the crown molding jig 10. The crown molding jig may have corresponding apertures 58 (see FIG. 1) matching the bolt mounting pattern on the bed 56 of the electric saw 50. The crown molding jig 10 may be aligned to the electric saw 50 such that the face of the guides 30a, b are exposed to the cutting blade 52 of the electric saw 50. Moreover, the corresponding apertures 58 may be configured and located such that the cutting blade 52 is aligned to the saw guide 32 when the cutting blade of the miter saw is set to zero in both directions of the compound angle cut. For jigs 10 mounted to a saw 50, the saw guide 32 is optional, (e.g., power or manual).

The crown molding jig 10 may also be used to form compound angle cuts in the distal end portions 44a, b of the first and second crown molding 12a, b such that the distal exterior edges 14a, b of the first and second crown moldings 12a, b are flush with each when the first and second crown moldings are oriented at an angle of about 270°. In particular, the first and second crown moldings 12a, 12b are inserted into the guides 30b, 30a, respectively (i.e., opposite). The front surfaces 20a, b rests or lays flat upon the back surface 36a, b. Also, the bottom surface 24a, b rests or lays flat upon the bed surface 34a, b. The upper and lower blocks 38a, b and 40a, b respectively engages the ceiling engaging surfaces 18a, b and the wall engaging surfaces 22a, b to secure the crown molding 12a, b in the guides 30a, b. Alternatively, the first and second crown moldings 12a, b may be rotated about the longitudinal axis of the guides 30a, b by adjusting the upper and lower blocks 38a, b and 40a, b. Initially, the crown molding 12a may be secured within the guide 30b such that the crown molding 12a cannot rotate about the longitudinal axis of the guide 30b. A saw blade 52 may then be traversed (e.g., reciprocated) through the saw guide 32 to form the compound angle cut in the distal end portion 44a of the first crown molding 12a. Likewise, the second crown molding 12b may be inserted through the guide 30a. The saw blade 52 may then be traversed through the saw guide 32 to form the compound angle cut in the distal end portion 44b of the second crown molding 12b. The above orientation of the first and second crown moldings 12a, b to the first and second guides 30a, b forms cuts in the first and second crown moldings wherein the distal exterior edges 14a, b of the first and second crown moldings 12a, b are flush with each other when the first and second crown moldings 12a, b are placed at an angle of 270° apart from each other.

It is contemplated that the first and second guides 30a, b may be adjustably sized to fit other sizes of crown molding 12. In particular, the back surfaces 36a, b may have vertical slots 79. A threaded bolt 80 may be placed within each of the vertical slots 79. Also, the upper blocks 38a, b may be formed with apertures 81 (see FIG. 2) to receive the threaded bolts 80. A wing nut 82 or other fastener may be tightened onto each of the threaded bolts 80. In this regard, the upper block 38a, b may be adjusted up or down depending on the size of the crown molding 12 to be cut. Similarly, the lower blocks 40a, b may be slid along horizontal slots 83 formed in the bed surface 34a, b. In particular, threaded bolts 84 (see FIG. 2) may be placed within each of the horizontal slots 83. Also, the lower blocks 40a, b may be formed with apertures 85 to receive the threaded bolts 84. A wing nut 86 be tightened onto each of the threaded bolts 84. The lower block 40a, b may be pushed in or out depending on the size of the crown molding 12 to be cut.

The back surfaces 36a, b may each have two sets of aligned graduations 87 (see FIG. 2) to align the upper blocks 38a, b to the bed surfaces 34a, b such that the upper blocks 38a, b are parallel to the bed surfaces 34a, b. Similarly, the bed surfaces 34a, b may each have two sets of aligned graduations to align the lower blocks 40a, b to the back surfaces 36a, b such that the lower blocks 40a, b are parallel to the back surfaces 36a, b. Other alignment systems are also contemplated.

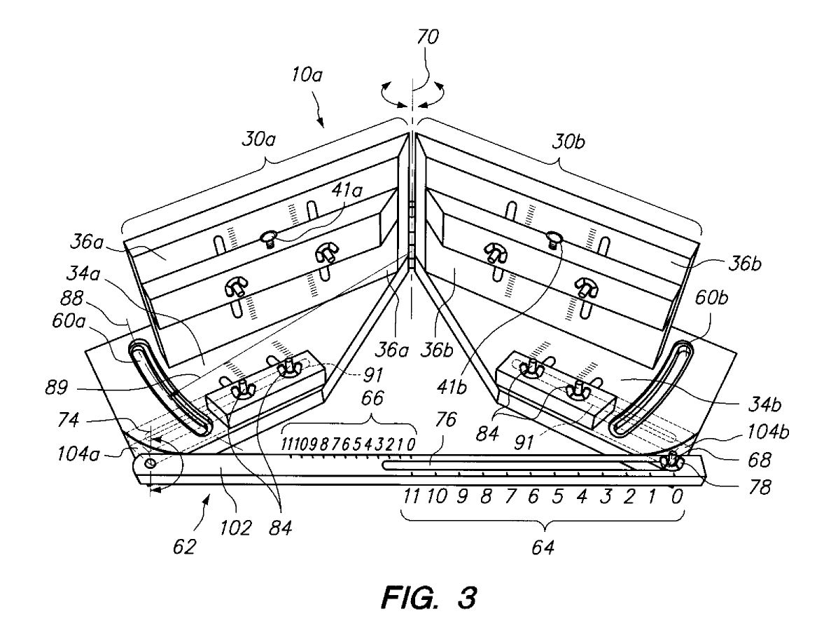

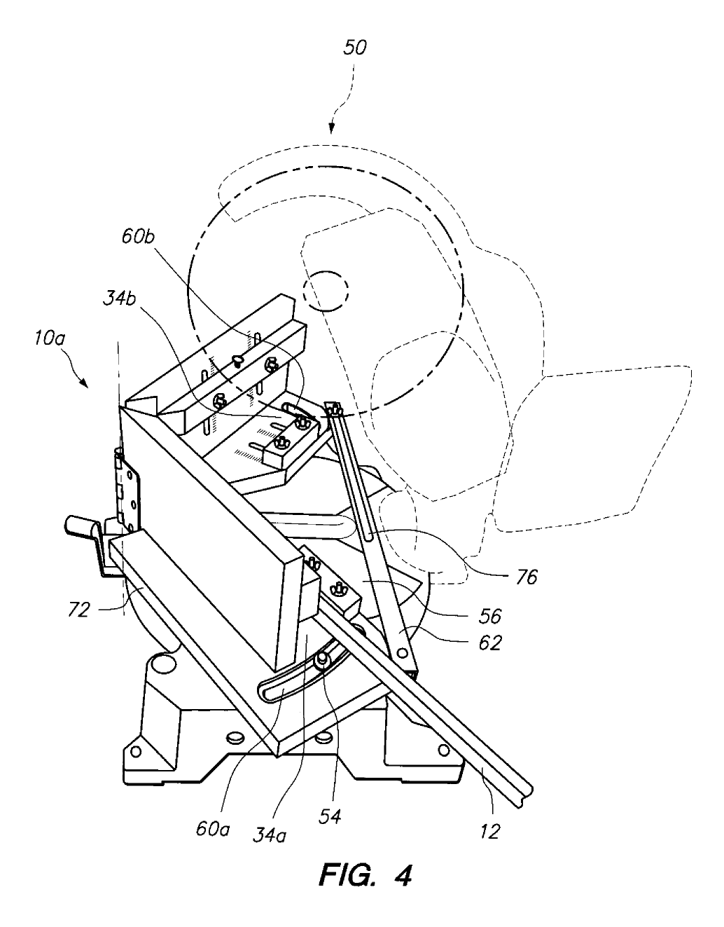

In a second embodiment of the crown molding jig 10a, referring now to FIGS. 3 and 4, the crown molding jig 10a may be adjustable such that the angular relationship between the first and second crown moldings 12a, b or first and second guides 30a, b may be between 60° and 135° or 300° and 225°. These ranges are merely provided for exemplary purposes and not to limit the crown molding jig 10a. The first and second guides 30a, b may be rotatably hinged to each other to achieve these angular ranges. The crown molding jig 10a may have the same structure compared to the crown molding jig 10 discussed in relation to FIGS. 1 and 2 except that the guides 30a, b of crown molding jig 10a are angularly adjustable.

The crown molding jig 10a may also be installed on an electric saw 50 as shown in FIG. 4. In particular, the back gage of the electric saw 50 may be removed from the electric saw. Typically, the back gage is attached to the bed 56 of the electric saw 50 with two bolts that screw into the bed 56 of the electric saw 50. The crown molding jig 10a may have two curved and slotted through holes 60a, b for receiving the bolts 54 used to hold the back gage of the electric saw 50. Once the back gage of the electric saw is removed from the electric saw 50, the bolts 54 used to hold the back gage may be inserted through the through holes 60a, b of the crown molding jig 10a and the bolt apertures formed in the bed 56. The bolts 54 may be tightened to secure the crown molding jig 10a to the bed 56 of the electric saw 50.

The through holes 60a, b may further be recessed such that a top of the bolt 54 is level with the bed surfaces 34a, b such that despite the size of the crown molding, the bolt 54 does not interfere with the insertion of the crown molding into the guides 30a, b. Moreover, the curvature 88 of the through holes 60a, b may be formed by forming a constant radius 89 about the pivot axis 70 of the guides 30a, b. In this manner, the pivot axis 70 remains at the same spot on the bed 56 of the electric saw 50 despite the angle between the guides 30a, b.

To properly install the crown molding jig 10a onto the electric saw 50, the saw blade 52 should be in the middle of the first and second guides 30a, b. By way of example and not limitation, if the first and second guides 30a, b are placed ninety degrees apart from each other, then the saw blade 52 should be positioned so as to be forty five degrees away from the first guide 30a and forty five degrees away from the second guide 30b. To angularly dispose the saw blade in the middle of the first and second guides 30a, b, a cross bar 62 may have two different scales 64, 66 which correspond to each other. The first scale 64 may be marked along a slotted side of the cross bar 62. The second scale 66 may be marked along the non slotted side of the cross bar 62. When the first and second guides 30a, b are angularly displaced such that the threaded pin 68 is aligned to “0” of the first scale 64, the cutting blade 52 of the electric saw should be aligned to the center pivot point axis 70 of the first and second guides 30a, b and “0” of the second scale 66. In another example, when the first and second guides 30a, b are angularly displaced such that the threaded pin 68 is aligned to “3” of the first scale 64, the cutting blade 52 of the electric saw 50 should be aligned to the center pivot point axis 70 of the first and second guides 30a, b and “3” of the second scale 66.

In use, the adjustable crown molding jig 10a may first be physically placed in the corner in which the first and second crown moldings 12a, b are to be installed. The rear surfaces 72 (see FIG. 4) of the first and second guides 30a, b may be flat and aligned to the first and second guides 30a, b, respectively. The rear surfaces 70 of the first and second guides 30a, b are placed against the walls of the corner. As such, the first and second guides 30a, b are rotated to match the angle of the walls of the corner. A separate device to determine the angle of the corner of the wall is not needed. If the corner has a 100° angle, then the first and second guides 30a, b of the adjustable jig 10a are also set to 100°.

The cross bar 62 may be attached to the first and second guides 30a, b to set or fix the angular relationship between the first and second guides 30a, b. hi particular, the cross bar 62 may be rotatably attached to the first guide 30a about pivot axis 74 (see FIG. 3). An opposed distal portion of the cross bar 62 may have a slot 76 through which the threaded pin 68 which is fixedly attached to the second guide 30b, may slide to allow the first and second guides 30a, b to pivot with respect to each other. When the crown molding jig 10a is physically placed against the walls of the corner, the first and second guides 30a, b are rotated to the angle of the corner. At this time, a wing nut or other fastener 78 may be tightened onto the pin 68 to prevent the pin 68 from sliding within the slot 76 of the cross member 62 and changing the angle of the first and second guides 30a, b. When the crown molding jig 10a is removed from the corner, the cross bar 62 maintains the angular relationship between the first and second guides 30a, b. The cross bar 62 may define a top surface 102. The top surface 102 of the cross bar 62 may be level with or below the bed surfaces 34a, b of the first and second guides 30a, b. To this end, the bed surface 34a may be recessed 104a. Also, the bed surface 34b may be recessed 104b. The top surface 102 of the cross bar 62 should be level with or below the bed surfaces 34a, b such that the cross bar 62 on the slotted side may slip under the crown molding inserted into the second guide 30b.

The crown molding installer may cut the first and second crown molding 12a, b with a hand saw utilizing the crown molding jig 10a. The upper slot of the saw guide 32 may be defined by the adjacent ends of the back surfaces 36a, b. The lower slot of the saw guide may be formed by sliding the lower blocks 40a, b toward the middle. In particular, the bolts 84 may be slid within slots 91 shown in dashed lines in FIG. 3. The bed surfaces 34a, b may have graduations to which a mark on the lower blocks 40a, b may be aligned. The marks on the lower blocks should be aligned to the same graduation to ensure that the lower slot formed by the lower blocks 40a, b is in the middle. Alternatively, the crown molding installer may cut the first and second crown molding 12a, b with an electric saw 50 utilizing the crown molding jig 10a. Thereafter, the cut first and second crown moldings 12a, b may then be installed in the corner of the room.

The first and second crown moldings 12a, b may be inserted through the guides 30a, b in a reverse direction as explained above to form compound angle cuts in the distal end portions 34a, b of the first and second crown moldings 12a, b such that the distal exterior edges 14a, b are flush with each other when the first and second crown moldings 12a, b are arranged at an angle between about 225° and 270°.

The crown molding jig 10a may have adjustable upper and lower blocks 38a, b, 40a, b similar to the adjustable upper and lower blocks discussed above in relation to crown molding jig 10. Additionally, crown molding jig 10a may also employ the lock bolts 41a, b discussed in relation to jig 10 to longitudinally lock the crown moldings 12a, b to the guides 30a, b.

In both crown molding jigs 10a, b discussed herein, the upper and lower blocks 38a, b and 40a, b may be fixed to the back surfaces 36a, b and bed surfaces 34a, b in that the upper and lower blocks 38a, b and 40a, b are not adjustable. Rather, the consumer may be provided with a plurality of different sized crown molding jigs 10, 10a in popular sizes of crown moldings (e.g., 3″, 5″ and 8″). The consumer would select the proper sized crown molding jig 10, 10a based on the size of the crown molding 12a, b to be installed. By way of example and not limitation, the fixed version may be fabricated by plastic injection molding the guides 30a, b, upper blocks 38a, b and the lower blocks as a unitary piece.

One of the benefits of the crown molding jig 10, 10a described herein is that the crown molding installer does not have to continually change the saw blade angles to make the compound angle cut in the mating crown moldings. Rather, the saw guide guides a hand saw to form the compound angle cuts in both the first and second crown moldings. Also, when the crown molding jig 10, 10a is mounted to an electric saw (e.g., miter saw, table saw, etc), the saw blade is adjusted to both the first and second crown molding guides at the same time.

In an aspect of the crown molding jig 10a shown in FIGS. 3 and 4, it is contemplated that the cross bar 62 be replaced with an expandable bushing. In particular, the pivot axis 70 is defined by a pin that holds the hinge attached to the guides 30a, b together. The expandable bushing may replace the pin. When the crown molding jig 10a is physically placed against the walls of the corner, the first and second guides 30a, b are rotated to match the angle of the corner. At this time, the expandable bushing may be expanded to fix the hinge in place and set the angle of the first and second guides 30a, b. The expandable bushing frictionally engages the bracket to hold the bracket and first and second guides in place when the crown molding jig 10a is removed from the corner. Alternatively, the cross bar 62 may be replaced with a lever lock hinge or a friction hinge which may be adjustable such as those sold by McMaster Carr. A friction hinge provides frictional resistance through a range of rotational motion of the hinge. A lever lock hinge can release or reduce frictional resistance such that the hinge may be adjusted then a lever can be actuated to lock the hinge in a particular angular position without the need for secondary mechanical support.

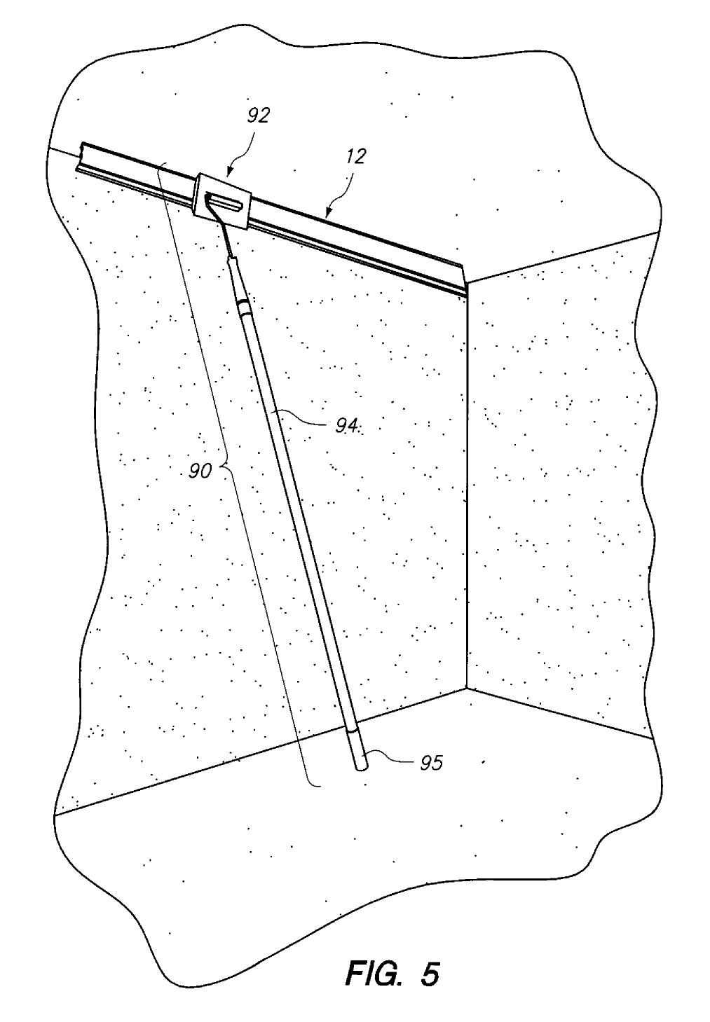

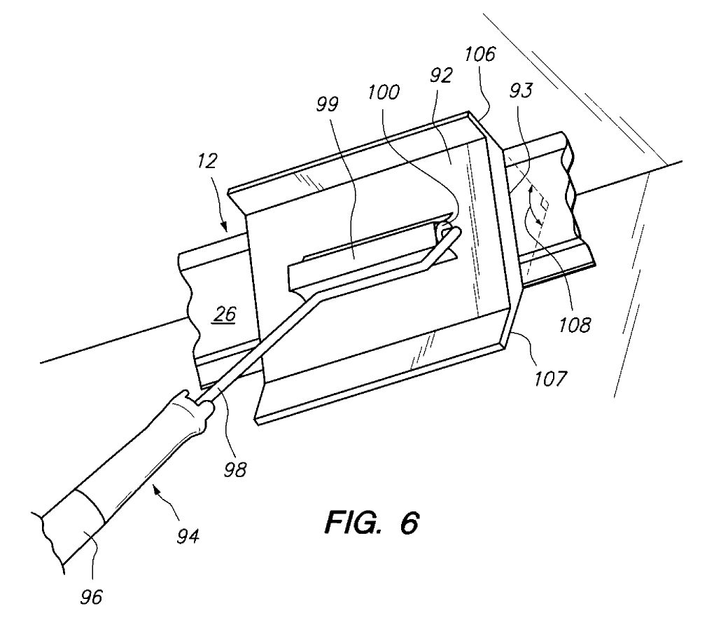

Referring now to FIGS. 5 and 6, a crown molding holder 90 is provided. The crown molding holder 90 may have an upper holding member 92 (see FIG. 6) which may have a holding surface 93 having a flat configuration. A ceiling engaging surface 106 may be formed above the holding surface 93. Also, a wall engaging surface 107 may be formed below the holding surface 93. The ceiling engaging surface 106 and the wall engaging surface 107 may be formed to have an angle 108 equal to the angle of the ceiling and the wall such as 90 degrees. The flat holding surface 93, ceiling engaging surface 106 and the wall engaging surface may also be lined with a cushion (e.g., sponge) such that when the upper holding member 92 is pushed against the crown molding 12, the cushion conforms to the configuration of the exterior surface 26 of the crown molding 12 as well as engages the ceiling and wall. The upper holding member 92 may be pivotably attached to an extension pole 94 having a length sufficient to abut the upper holding member 92 against the crown molding 12 held up to the ceiling and wedge a lower distal end 95 of the extension pole 94 against the ground. The extension pole 94 may be spring loaded such that the lower distal end 95 of the extension pole 94 may apply a force to the ground. The lower distal end of the extension pole may have friction material (e.g., rubber) attached thereto to prevent the extension pole from slipping off of the ground.

The upper holding member 92 may be pivotally attached to the extension pole 94 in the following manner. In particular, the upper distal end 96 of the extension pole 94 may be attached to a paint roller 98. The paint roller 98 may be pivotally secured to the upper holding member 92 by attaching a channel 99 to the upper holding member 92 and inserting the roller portion 100 of the paint roller 98 into the channel 99.

The crown molding holder 90 may be used to hold the crown molding 12 in place during installation of the crown molding 12. In particular, as discussed in the background, installation of crown molding 12 is a two person job. A helper holds one end of the crown molding while installer nails or attaches the crown molding 12 to the ceiling. The crown molding holder 90 eliminates or reduces the need for the helper thereby reducing the cost of labor to install crown molding 12. The installer climbs up a ladder to place crown molding 12 adjacent the ceiling. The ceiling engaging surface 106 engages the ceiling. The wall engaging surface 107 engages the wall. The holding surface 92 engages the crown molding. The installer additionally wedges the lower distal end 95 of the extension pole 94 against the floor. Thereafter, the installer may attach (e.g., nail, screws, etc.) the crown molding to the ceiling. The above process of installing the crown molding 12 with the crown molding holder 90 permits installation of crown molding 12 by one person.

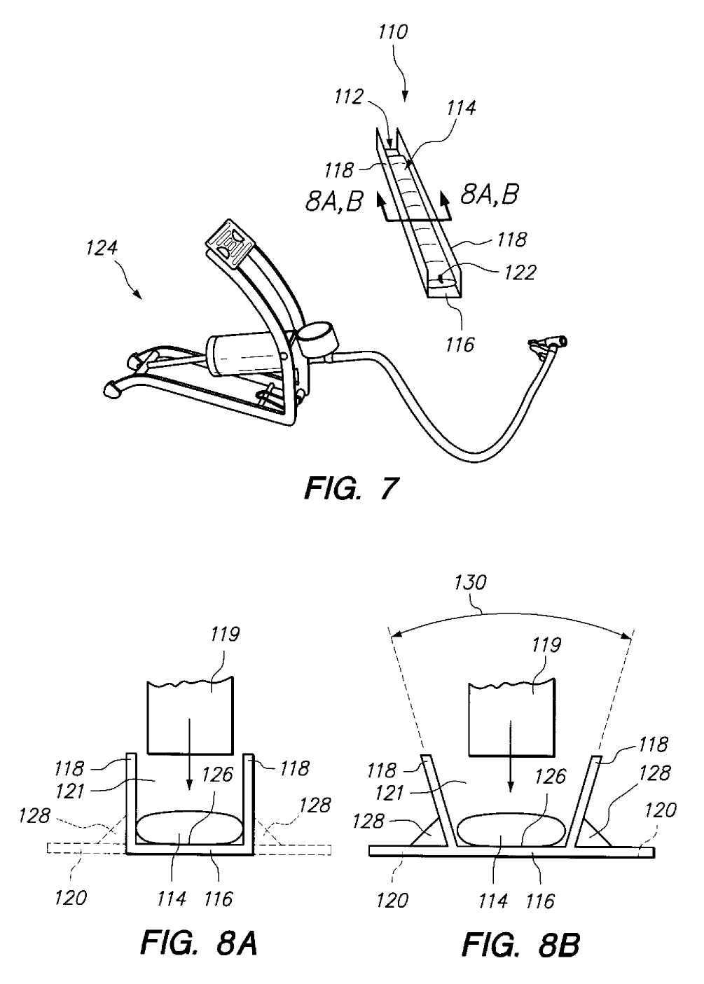

Referring now to FIGS. 7, 8A and 8B, a door installation jig 110 may have a U-shaped channel 112 and inflatable tube 114 disposed within the U-shaped channel 112. The U-shaped channel 112 may define a base member 116 which is restable on a floor. Opposed vertical walls 118 may be attached to the base member 116. The opposed vertical walls 118 may extend perpendicular with respect to the base member 116, as shown in FIG. 8A. The opposed vertical walls 118 may be spaced apart in parallel relationship with each other so as to receive a bottom portion of a door 119. The door 119 may slide vertically up and down in the space 121 formed by the opposed vertical walls 118. Alternatively, the opposed vertical walls 118 may be spread open such that the upper distal ends of the opposed vertical walls 118 are further apart compared to the lower distal ends of the opposed vertical walls, as shown in FIG. 8B. The opposed vertical walls 118 may have a mirror image with respect to each other. Additionally, the opposed vertical walls 118 may form an angle 130 between five and fifteen degrees. The inflatable tube 114 may be disposed between the opposed vertical walls 118 and on the base member 116. Alternatively, the inflatable tube 114 may be disposed underneath the base member 116. Additionally, the inflatable tube 114 may be attached to the channel 112, and more particularly, to the base 116. The length of the inflatable tube 114 may extend substantially along the entire length of the door 119 to balance the door in its longitudinal direction. By way of example and not limitation, the inflatable tube 114 may be about three quarters the length of the door 119. The length of the opposed vertical walls 118 may extend to a distance equal to the length of the inflatable tube 114, up to the length of the door 119, or greater than the length of the inflatable tube 114. It is also contemplated that the inflatable tube 114 may be about ¼ of the length of the door 119. In this regard, the valve 122 may be fabricated to be in pneumatic communication with the inflatable tube but away from the door itself such that the foot pump 124 may be attached to the valve 122. A hose may be connected to the valve 122 and the inflatable tube 114. Also, the inflatable tube 114 may be placed centrally under the door 119 to balance the door along its longitudinal length.

Flanges 120 may also be formed on the base member 116 which extend horizontally outward to provide more stability during use of the door installation jig 110. The opposed vertical walls 118 may also be supported by ribs 128 positioned along the length of the channel 112.

The inflatable tube 114 may have an elongate cylindrical configuration with a valve 122 connected thereto. By way of example, the inflatable tube may be a bicycle tire tube cut and sealed on both ends. The valve 122 may be connectable to a foot air pump 124 such as a bicycle foot pump.

In use, the door 119 may be initially unhung from a door frame. To install the door 119 to the door frame, hinges must be attached to both the door frame and the door. To this end, the hinge side of the door may be fabricated with a recess to fit a first part of a hinge. Similarly, the hinge jamb of the door frame may fabricated with a recess to fit a second part of the hinge. The recesses fabricated in the binge side of the door and the hinge jamb of the door are positioned such that when the hinge is attached to the door and door frame, the door is level to the door frame. Thereafter, the door installation jig 110 may be placed adjacent the hinge jamb of the door frame at about a forty five angle to the door opening. The base member 116 and the optional flanges 120 rest upon the floor. The opposed vertical walls 118 extend upwardly. The door 119 may then be placed between the opposed vertical walls 118 with the inflatable tube 114 between the base member and the bottom portion of the door 119. The door 119 is not placed over the valve 122. The door hinge side may then be aligned to the hinge jamb of the door frame. The door installer may then operate the foot pump 124 to displace air into the inflatable tube 114. As the inflatable tube 114 is filled with air, the door 119 is raised off of the floor. Air is continuously pumped or displaced into the inflatable tube 114 until the door is level with the door frame (i.e., recess formed in hinge side of door is level with the recess formed in the hinge jamb of the door frame). The installer may then move the door 119 along with the door installation jig 110 to align the door hinge edge closely adjacent to the binge jamb of the door frame. The bottom surface of the base 116 and optional flanges 120 may be coated with antifriction material such that the door can slide on the floor. The installer may then place the upper and lower hinges adjacent the door and the hinge jamb of the door frame. Pilot holes may be drilled in the door and the hinge jamb. Screws may be used to attach the upper and lower hinges to the door and the hinge jamb of the door frame. After installation of the door 119 to the door frame, the air may be released from the inflatable tube 114 through the valve 122. The door installation jig 110 may be slid out from under the installed door.

It is contemplated that the crown molding jig 10, 10a, crown molding holder 90, door installation tool 110 or components thereof may be fabricated utilizing various method and material. By way of example and not limitation, the crown molding jig 10, 10a, crown molding holder 90, door installation tool 110 or components thereof may be fabricated from wood, metal, plastic, rubber or other materials that would suite the needs of the crown molding jig 10, 10a, crown molding holder 90, door installation tool 110 or components thereof discussed herein. Moreover, the crown molding jig 10, 10a, crown molding holder 90, door installation tool 110 or components thereof discussed herein may be fabricated by injection molding techniques, casting, machining, or other methods so as to suite the needs of the devices 10, 10a, 90, 110.

The door installation jig 110 may be used to install heavy or light door. However, the door installation jig 110 is particularly useful to permit door installation of heavy doors by one person.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. A molding jig for cutting adjacent moldings to form a seamless joint at a corner of first and second walls, the molding jig comprising:
a first molding guide sized and configured to allow a first molding to slide in and out of the first molding guide and rotationally fix the first molding within the first molding guide at an angle so as to mimic a proper orientation of the first molding on the first wall; and
a second molding guide sized and configured to allow a second molding to slide in and out of the second molding and rotationally fix the second molding within the second molding guide at an angle so as to mimic a proper orientation of the second molding on the second wall and in relation to the first molding, the second molding guide attached to the first molding guide at a fixed angle between one degree and one hundred seventy nine degrees.

2. The molding jig of claim 1 wherein the first and second molding guides each have at least four surfaces, four of the surfaces collectively forming a rectangular shape and receiving a respective one of a ceiling engaging surface, a front surface, wall engaging surface, and a bottom surface of the first and second moldings.

3. The molding jig of claim 1 further comprising a saw guide disposed between the first and second guides wherein an angle between the saw guide and the first molding guide is about equal to an angle between the saw guide and the second molding guide.

4. The molding jig of claim 3 wherein the molding guides define bed surfaces and the saw guide extends through an entire depth of the bed surfaces for permitting a saw blade of a miter saw to extend therethrough.

5. (canceled)

6. (canceled)

7. The molding jig of claim 1 further comprising a pattern of fastener holes matching a bolt pattern of a bed of the saw.

8. The molding jig of claim 1 wherein each of the first and second molding guides comprise:
a back surface;
an upper block slideably attached to the back surface;
a bed surface perpendicular to the back surface, the bed surface being parallel with respect to a lower surface of the upper block; and
a lower block slideably attached to the bed surface, a side surface of the lower block being parallel to the back surface.

9. The molding of claim 8 further comprising:
a first bolt receivable into a vertical slot formed in the back surface of the first guide and an aperture formed in the upper block of the first guide;
a first nut tightenable onto the first bolt for adjusting a position of the upper block of the first guide on the back surface of the first guide;
a second bolt receivable into a vertical slot formed in the back surface of the second guide and an aperture formed in the upper block of the second guide;
a second nut tightenable onto the second bolt for adjusting a position of the upper block of the second guide on the back surface of the second guide.

10. The molding jig of claim 1 further comprising a lock screw attached to the first guide for longitudinally locking the first molding in the first molding guide.

11. The molding jig of claim 1 wherein the first and second molding guides are each defined by a bed surface, a back surface, an upper block and a lower block, the lower blocks being disposed on inner sides with respect to the first and second molding guides and traversely adjustable with respect to a longitudinal axis of the first and second molding guides.

12. The molding jig of claim 1 wherein the open first surface and open second surface are rear surfaces of the first and second guides, respectively.

13. The molding jig of claim 1 wherein the second molding guide is attached to the first molding guide at a fixed angle of about ninety degrees.

14. The molding jig of claim 8 wherein the first molding guide is sized and configured to rotationally fix the first molding within the first molding guide at a first skewed angle with respect to the back surface of the first molding guide and the second molding guide is sized and configured to rotationally fix the second molding within the second molding guide at a corresponding second skewed angle with respect to the first skewed angle to mimic the first and second moldings at the corner of the first and second walls.

15. A molding jig for cutting adjacent moldings to form a seamless joint at a corner of first and second walls, the molding jig comprising:
a first molding guide sized and configured to allow a first molding to slide in and out of the first molding guide and rotationally fix the first molding within the first molding guide, the first molding guide having an open first surface contactable with the first wall and aligned to the first molding guide; and
a second molding guide sized and configured to allow a second molding to slide in and out of the second molding and rotationally fix the second molding within the second molding guide, the second molding guide having an open second surface contactable with the second wall and aligned to the second molding guide, the second molding guide adjustably attached to the first molding guide at an angle between one degree and one hundred seventy nine degrees, the angle between the first and second molding guides adjusted to match an angle of the corner of the first and second walls when the open first surface contacts the first wall and the open second surface contacts the second wall.

16. The molding jig of claim 15 further comprising a friction hinge or a lever lock hinge attached to the first and second molding guides for setting an angular relationship between the first and second molding guides.

17. The molding jig of claim 15 further comprising a cross bar pivotally attached to the first guide and slideably attached to the second guide for fixing the angular relationship between the first and second guides.

18. A method of cutting first and second crown molding to form a seamless joint in a corner of first and second walls, the method comprising the steps of:
providing a jig having first and second molding guides rotatably hinged to each other;
pushing first and second open surfaces of the first and second molding guides against the first and second walls to adjust an angle of the first and second molding guides to match an angle of the corner of the first and second walls;
setting the angle of the first and second molding guides;
inserting one of the first and second crown moldings into the first molding guide;
cutting a first compound angle in the one of the first and second crown moldings;
removing the one of the first and second crown molding from the first molding guide;
inserting the other one of the first and second crown molding into the second molding guide;
cutting a second compound angle in the other one of the first and second crown molding that corresponds to the first compound angle in the one of the first and second crown moldings;
mounting the first crown molding to one of the first and second walls; and
mounting the second crown molding to the other one of the first and second walls.

19. The method of claim 18 wherein the setting step comprises the step of fixing the angle of the first and second molding guides.

20. The method of claim 18 wherein the setting step comprises the step of frictionally holding the angle of the first and second molding guides.

21. The method of claim 18 wherein the pushing step comprises the step of pushing rear surfaces of the first and second molding guides against the first and second walls.
